(19) United States
(12) Patent Application Publication
(10) Pub. No.: US 2014/0172466 A1
(43) Pub. Date: Jun. 19, 2014

(54) Shared Medical Data Platform for Insurance Underwriting

(71) Applicant: INNODATA SYNODEX, LLC, Hackensack, NJ (US)

(72) Inventors: Richard D. Kemp, Edgewater, NJ (US); Sam Jensen, Larchmont, NY (US)

(73) Assignee: Innodata Synodex, LLC, Hackensack, NJ (US)

(21) Appl. No.: 13/716,736

(22) Filed: Dec. 17, 2012

(51) Int. Cl. G06Q 40/08; G06Q 50/24

(52) U.S. Cl. CPC G06Q 40/08; G06Q 50/24
USPC 705/4

(57) ABSTRACT

Methods, apparatuses, and computer readable media for implementing a shared medical data platform are provided. A shared medical data platform may be implemented by effecting processing of a medical file to generate a medical report. Data regarding the medical report is distributed to a plurality of insurance underwriters, wherein the data is used to facilitate a bidding or quotation process between the plurality of insurance underwriters to offer insurance underwriting services to a client associated with the medical report. A fee is determined for effecting processing of the medical file, and payment of the fee by at least one of the plurality of insurance underwriters is facilitated based on whether the bidding or quotation process results in an offer of insurance underwriting services to the client associated with the medical report.

### TECHNICAL FIELD

The present disclosure is generally directed to processing medical records, and more specifically to processing medical records for the purpose of sharing medical record data in a normalized format and to facilitate automated insurance underwriting processing and decision making.

### BACKGROUND

Collecting useful data from medical records is often tedious. Medical records related to a particular individual are often stored at disparate locations. Once these records are located, the task of gathering and analyzing the records is often labor-intensive. Typically, records must be organized and mined for data. Further, if the data is being gathered for input to an automated process, such as an automated insurance underwriting process, the records may also need to be formatted and data expressed in a normalized manner.

While current methods of processing medical records for automated processes can be useful, these methods are often informal and disorganized. Processing errors and other abnormalities often occur, which may cause automated processes that utilize the records to be inaccurate. At the very least, such inaccuracies can cause delays to automated processes when they are discovered.

Further, inaccurate methods of processing medical records can make distributing or sharing processed medical records for automated insurance underwriting processes impractical.

### SUMMARY

Methods, apparatuses, and computer readable media for implementing a shared medical data platform are provided. In general, a shared medical data platform may be desirable for insurance underwriters and agents procuring insurance to share the various costs of processing medical records. It also may be desirable to distribute the costs of processing medical records for clients who are deemed to be uninsurable. In addition, normalized medical record data may be maintained for future modeling and risk assessment.

In accordance with an embodiment, a method for implementing a shared medical data platform includes effecting processing of a medical file to generate a medical report. Data regarding the medical report is distributed to a plurality of insurance underwriters, wherein the data is used to facilitate a bidding or quotation process between the plurality of insurance underwriters to offer insurance underwriting services to a client associated with the medical report. A fee is determined for effecting processing of the medical file, and payment of the fee by at least one of the plurality of insurance underwriters is facilitated based on whether the bidding or quotation process results in an offer of insurance underwriting services to the client associated with the medical report. The plurality of insurance underwriters may be associated with an insurance underwriter network. Data may be received from the client associated with the medical report authorizing an insurance underwriter to participate in the bidding or quotation process. A medical report may be structurally grouped into categories that include general health information, disease type, symptoms of disease, injuries, general diagnostic testing, biochemistry, microbiology and pathology, imaging, endoscopy, medical procedures and surgeries, medications and prescriptions, family history and restrictions. The medical report also may include related normalized XML data.

In accordance with an embodiment, facilitating payment of the fee may include billing an account of an insurance underwriter associated with a winning bid or quotation when the bidding or quotation process results in an offer of insurance underwriting services to the client associated with the medical report. Alternatively, the costs may be shared by one or more of the plurality of insurance underwriters.

In accordance with an embodiment, facilitating payment of the fee may include billing an account of one or more of the plurality of insurance underwriters when the bidding or quotation process does not result in an offer of insurance underwriting services to the client associated with the medical report. An account of each of the plurality of insurance underwriters who participated in the bidding or quotation process may be billed when the bidding or quotation process does not result in an offer of insurance underwriting services to the client associated with the medical report.

In accordance with an embodiment, the medical report may conform to one or more Association for Cooperative Operations Research and Development insurance data standards. The medical report may include normalized medical data and the normalized medical data may include one or more critical disease elements.

These and other advantages of the invention will be apparent to those of ordinary skill in the art by reference to the following detailed description and the accompanying drawings.

### BRIEF DESCRIPTION OF THE DRAWINGS

FIG. 1A is a flowchart of a process for medical record processing in accordance with an embodiment;

FIG. 1B illustrates a heat map based on one or more coded files in accordance with an embodiment;

FIG. 2 is a workflow diagram showing a system that may be used for processing medical records in accordance with an embodiment;

FIG. 3A illustrates a page of a medical file in accordance with an embodiment;

FIG. 3B illustrates another page of a medical file in accordance with an embodiment;

FIG. 4 illustrates a data-point file in accordance with an embodiment;

FIG. 5 illustrates a preliminary classification of a particular data point of a data-point file in accordance with an embodiment;

FIG. 6 illustrates a coded file in accordance with an embodiment;

FIG. 7 is a diagram showing a system for implementing a shared medical data platform in accordance with an embodiment;

FIG. 8 is a flowchart of a process for implementing a shared medical data platform in accordance with an embodiment; and

FIG. 9 is a high-level block diagram of an exemplary computer that may be used for implementing a shared medical data platform.

### DETAILED DESCRIPTION

In accordance with the various embodiments, medical record processing as disclosed herein includes generating a medical report with data from an individual's medical records. Relevant data from medical record files is first extracted and then normalized based on standardized codes (e.g., ICD-10-CM disease and ICD-10-PCS procedure codes) or synthetic codes based on multiple variables (e.g., combinations of medical conditions, pain scales, lists of values or measurements). The generated medical report then may be formatted for input to an automated insurance underwriting process. The various embodiments support electronic data record processing for life, health and disability insurance underwriting processes. Moreover, the embodiments provide medical reports including normalized categories and formats that can be integrated with other medical record analyses and predictive models, including models for predicting disease trends.

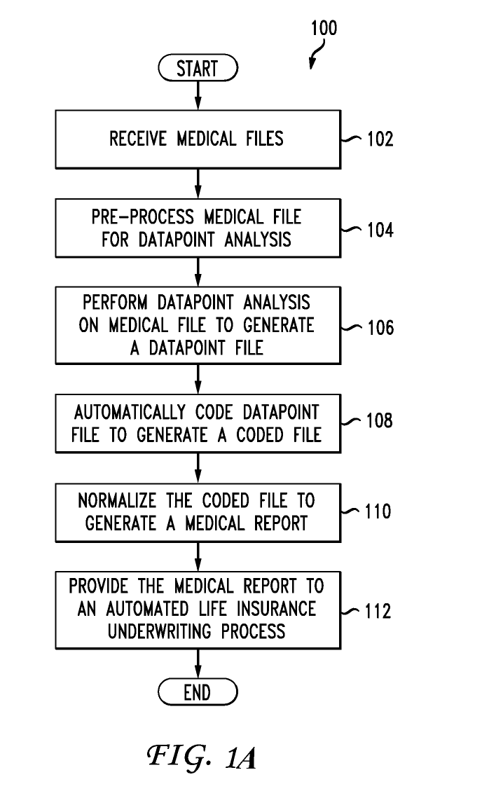

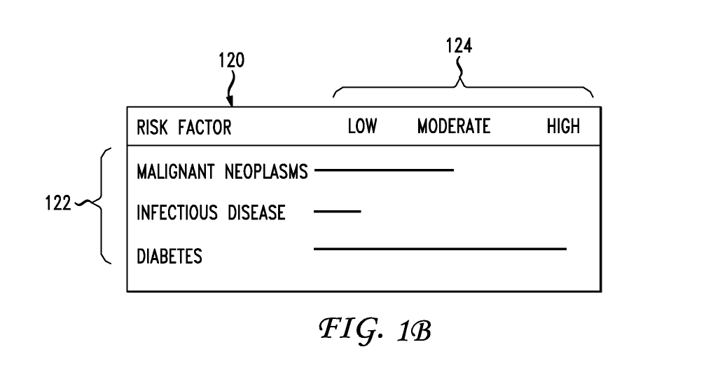

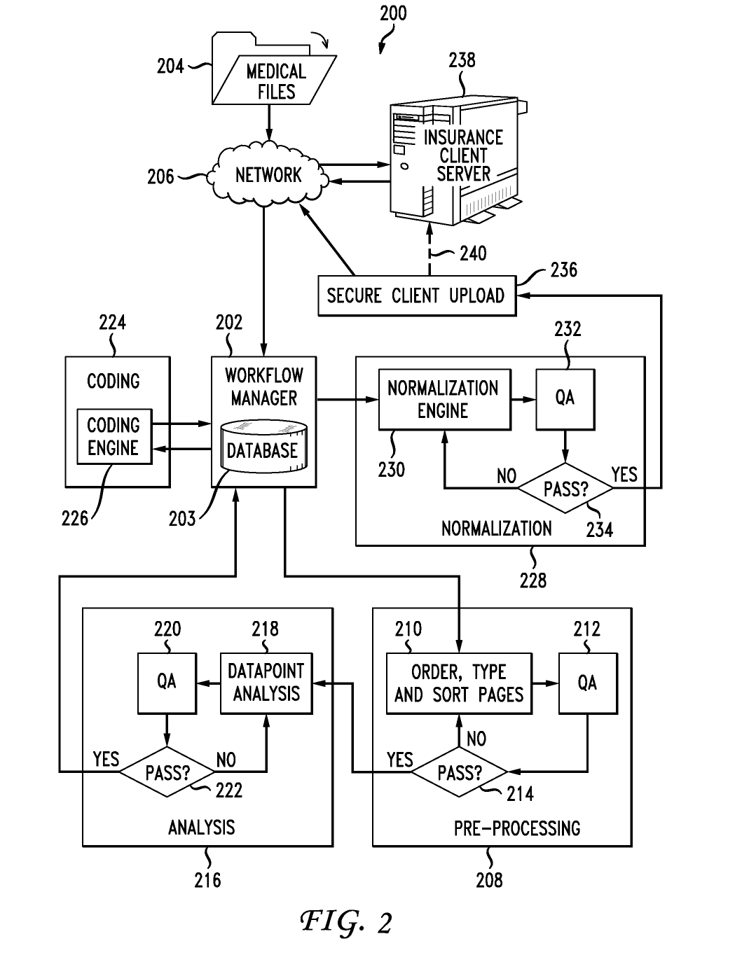

FIG. 1A is a flowchart of a process for medical record processing in accordance with an embodiment. Process 100 presents a summary of the methods employed for medical record processing, as detailed in the work flowchart of FIG. 2. In process 100, data point analysis is performed on a medical file to generate a data-point file, the data-point file is automatically coded to generate a coded file and the coded file is normalized to generate a medical report. For example, a medical file is received at a workflow manager at 102. At 104, the medical file is pre-processed for data-point analysis. For example, pre-processing may include removing non-relevant information from the medical file, such as regulatory or personal information. At 106, data point analysis is performed on the medical file to generate a data-point file. In one embodiment, data point analysis may be performed based on a predefined data point specification. For example, the data point specification may be based on one or more coding standards such as CPT, MeSH, MIB, ICD-10, ICD-10-PCS or ICD-10-CM. Performing data point analysis also may include identifying probable errors in the medical file (e.g., clearly erroneous notations of diagnoses or prescribed medications), and correcting such erroneous data.

The data-point file is automatically coded to generate a coded file at 108. For example, the data-point file may comprise a plurality of data-points and automatically coding the data-point file (e.g., via a coding engine) may comprise assigning one or more CPT, MeSH, MIB, ICD-10, ICD-10-PCS or ICD-10-CM codes or, alternatively, synthetic codes to the data-points. At 110, the coded file is normalized to generate a medical report. In one embodiment, the automatic coding at 108 may be based at least in part on feedback from one or more prior normalizations.

At 112, the medical report is provided to an automated insurance underwriting process, such as via a secure client upload (e.g., either via a network or a direct connection). In one embodiment, a correlation may be determined between the coded file and mortality or life expectancy data, and the correlation may be provided to the automated insurance underwriting process (e.g., along with the medical report). For example, a life expectancy prediction may be determined based on the correlation. In one embodiment, mortality data may be expressed as one or more mortality risk (MR) values that may be automatically provided in association with the medical report.

In another embodiment, a correlation may be determined between the coded file and reported individual or group symptoms or medical test results. The correlation may then be provided to the automated insurance underwriting process for predicting future disease trends. FIG. 1B illustrates a heat map based on one or more coded files in accordance with an embodiment. For example, a heat map 120 of individual or group medical conditions, diseases or symptoms may be generated based on a plurality of coded files provided to the automated insurance underwriting process. A heat map 120 of individual or group medical conditions may include a list or graphical representation of critical or important medical conditions that determine insurability. The list or graphical representation may be grouped by type of disease 122 or other risk factors. For example, a heat map may include color codes or other indications to represent relative risk in different medical groups. In one embodiment, one or more normalized data sources may be used to determine the classifications 124 (e.g., low, moderate, high) underlying the list or graphical representation. Alternatively, the heat map may be presented in the form of MR values or expressed in the form of insurance underwriters Table Risk. For example, insurance Table Risk typically includes range designations (e.g., Preferred Plus, Preferred, Standard Plus, Standard) and various tables of increasing risk and premium surcharges, e.g., from Table 1 through Table 16.

FIG. 2 is a workflow diagram showing a system for processing medical records in accordance with an embodiment. In system 200, workflow manager 202 is configured to manage and/or store (via database 203) one or more medical record files 204 (also referred to herein as medical files) received via network 206. For example, network 206 may be a private network (e.g., a company or healthcare provider intranet), a public network (e.g., the public Internet) supporting secure transmissions of machine-readable or imaged (e.g., PDF format) medical files or, alternatively, a combination of networks.

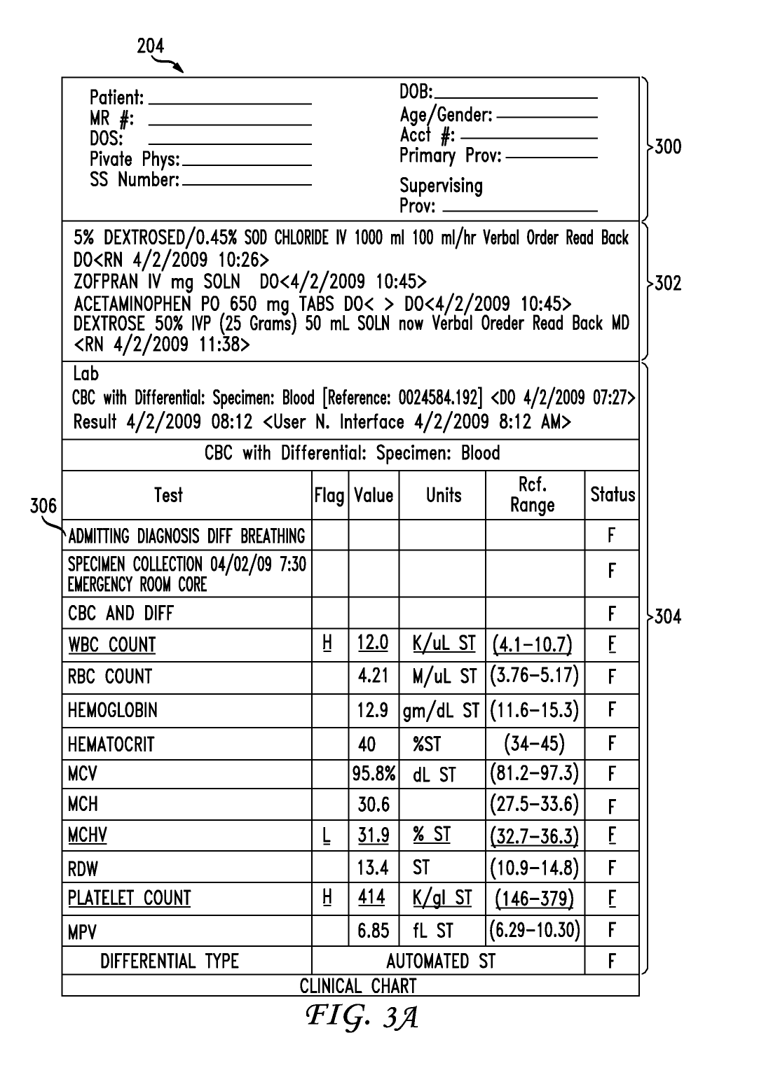

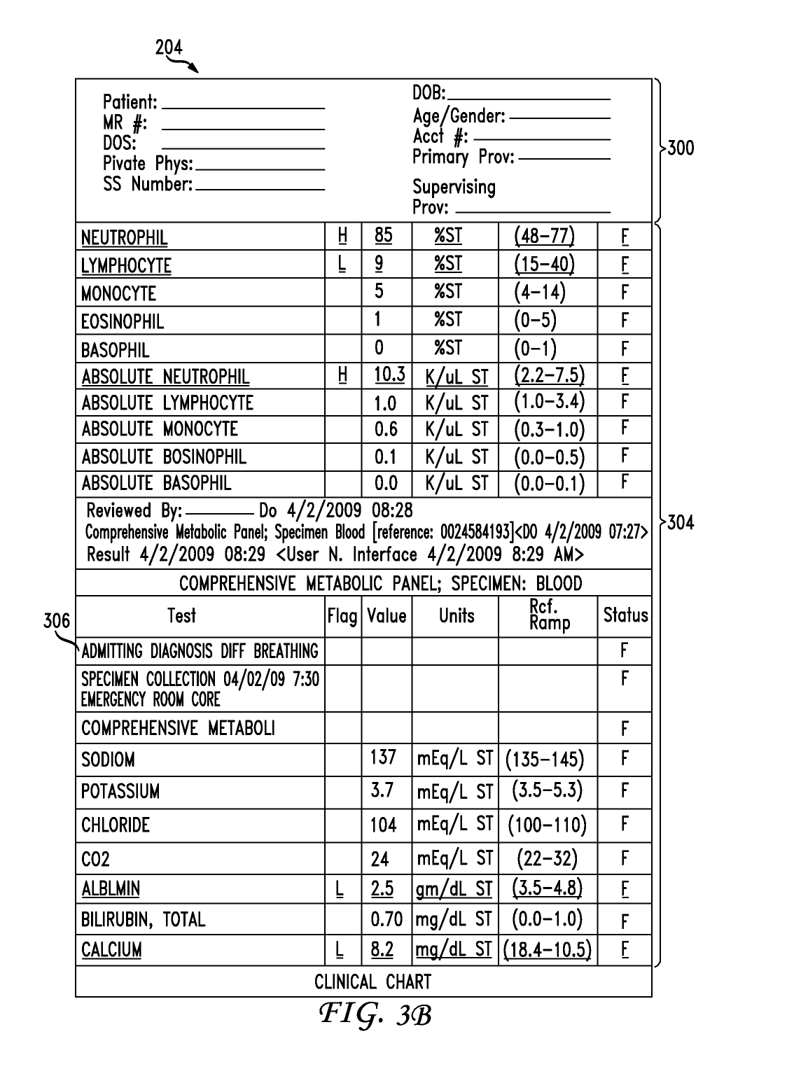

In one embodiment, medical files 204 may include raw data that can be processed to generate formatted medical reports, including medical reports that are useful for automated life, health or disability insurance underwriting processes. FIGS. 3A and 3B illustrate pages of a medical file in accordance with an embodiment. For example, medical file 204 may contain patient information 300, including address and billing information for an individual. Medical file 204 may also contain data associated with doctor visits including, treatments and prescribed medications 302, test results 304, diagnoses 306, and other data. A medical file 204 also may contain additional information, such as regulatory, administrative or general medical data.

Workflow manager 202 coordinates steps for processing a medical file 204 to generate a medical report. In one embodiment, workflow manager 202 coordinates the pre-processing of a medical file 204 by providing medical file 204 (e.g., a medical file stored in database 203) to pre-processing function 208. In pre-processing function 208, the medical file 204 is ordered (e.g., organized and/or classified), typed and/or sorted 210 for subsequent processing steps. For example, ordering, typing or sorting operations 210 for a medical file may include converting data (e.g., from machine-readable to human-readable formats, or vice versa), matching data with a particular individual or a plurality of individuals, and extracting data (e.g., regulatory or boilerplate sections) that is not relevant to subsequent processing.

Operations within pre-processing object 208 may be implemented automatically (e.g., by a machine), semi-automatically or manually. For example, at a remote location one or more humans (e.g., utilizing remote access terminals in communication with workflow manager 202 and database 203) may order, type or sort or otherwise pre-process a medical file 204. Moreover, additional personnel at the remote location (or at another location) may perform operations for quality assurance (QA) 212. For example, if a pre-processed medical file does not comply with QA standards, the file may be returned for additional ordering, typing or sorting operations, including error correction, at 214. In one embodiment, QA 212 is managed by comparing data entries to machine made classifications of disease based on, for example, a semantic analysis of expressions in text and expected relevancy to specific disease classifications. For example, for a text entry “moderate aortic stenosis”, machine analysis can rank the best probably match of the text entry to a code (e.g., “I35.0 Aortic (valve) stenosis”) based on one or more databases of relevancy rules.

If the pre-processed file is determined to be in compliance with QA standards, the pre-processed file is provided to analysis function 216 for data-point analysis. In one embodiment, the pre-processed file may be provided to analysis function 216 directly from the preprocessing location. Alternatively, the pre-processed file may be received by workflow manager 202 after preprocessing and then provided by workflow manager 202 to analysis function 216. In another alternative, medical file 204 may be provided to analysis function 216 directly by workflow manager 202 without being preprocessed.

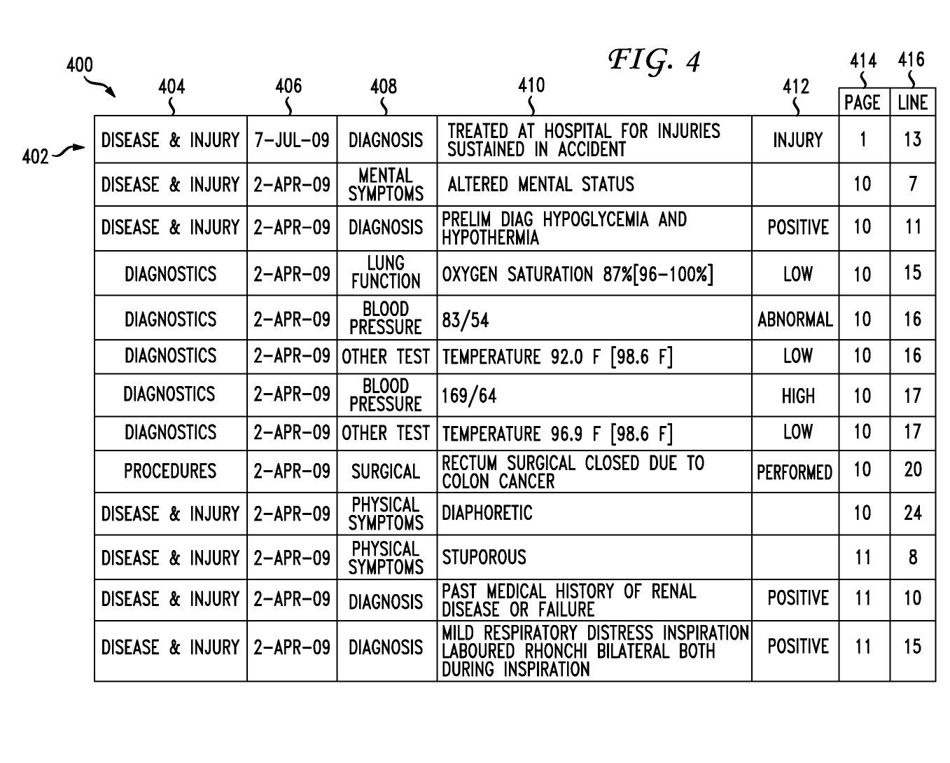

Analysis function 216 includes data-point analysis operations 218 for analyzing a medical file 204 based on one or more data-points to generate a data-point file. In one embodiment, a data-point is an extraction of particular data from a medical record in accordance with a specification. The format for data-points may be controlled for consistency, readability and relevancy to medical importance. One or more doctors, pharmacists, medical technologists or other trained medical professionals may perform data point analysis by manually or semi-automatically analyzing one or more data-points of a medical file 204 to generate a data-point file, as shown in FIG. 4. For example, data-point file 400 may be formatted to include one or more data points 402 containing columns for data point descriptions 404, dates-of-entry 406, subject matter 408 (e.g., diagnosis, test, procedure), actions performed/notations 410, assessments 412 and page 414 and line 416 numbers corresponding to the pages/lines containing the data point information in the original medical file 204.

In one embodiment, medical professionals may perform data point analysis on a medical file 204 at a remote location, such as at the pre-processing remote location or, alternatively, at another remote location relative to workflow manager 202. Additional personnel at the data point analysis remote location may perform quality assurance (QA) 220 on generated data-point files (e.g., by comparing data entries to machine made classifications of disease). For example, if a generated data point file does not comply with QA standards, the data point file may be returned for additional data point analysis or error correction at 222.

If the data point file is determined to comply with QA standards, the data point file is returned to workflow manager 202, which may provide the data point file for coding at coding function 224. For example, workflow manager 202 may provide the data point file to coding engine 226 for coding according to one or more medical record coding standards.

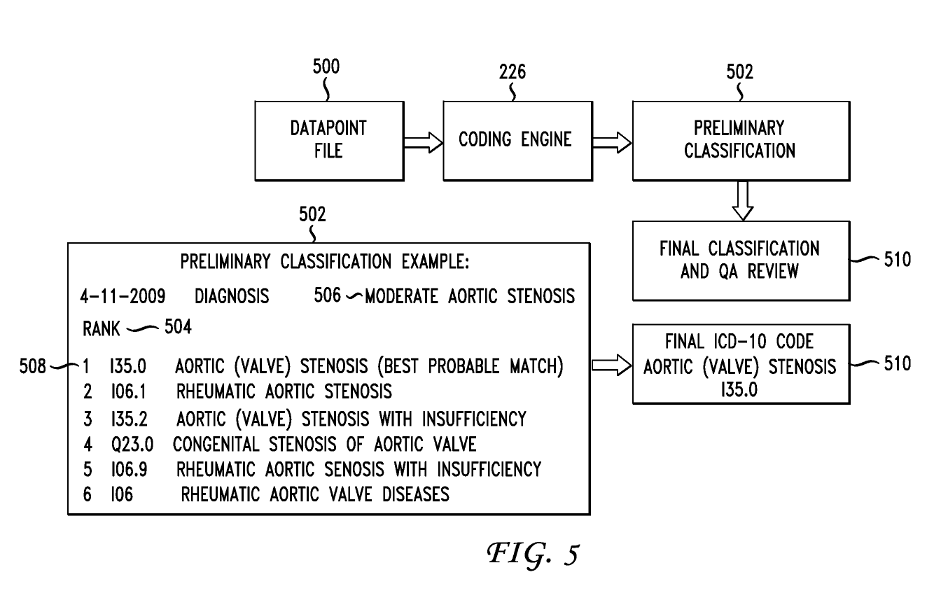

Coding engine 226 may be implemented via one or more devices external to workflow manager 202. As illustrated in FIG. 5, upon receiving a data-point file 500, coding engine 226 may be configured to automatically code a data point file (e.g., based on one or more medical record coding standards, such as CPT, MeSH, MIB, ICD-10, ICD-10-PCS, ICD-10-CM, etc., or synthetic codes) to generate a coded file.

For example, coding engine 226 may be configured analyze a data-point file to identify particular data points, such as data points that are undefined (e.g., data points that do not include a coded entry for a medical condition or diagnosis). Coding engine 226 then may employ search algorithms to determine codes for the particular data points. In one embodiment, coding engine 226 may employ one or more advanced analysis algorithms to determine a preliminary classification 502 (i.e., a probability ranking) of codes for particular data points based on data analysis (e.g., diagnosis correlation) criteria. For example, a preliminary classification 502 of a particular data point of a data-point file generated by coding engine 226 may include rankings of codes 504 that are probable matches for a given diagnosis 506, wherein the highest ranked code 508 may indicate the best probable match for the given diagnosis. The best probable match then may be included as a final classification 510 for the diagnosis 506 in a coded file.

In another embodiment, an advanced analysis algorithm may be based on the absolute semantic relevancy of two expressions. For example, an expression can be one or more words or symbols. Stored relevancy rules may then be accessed for processing a data-point. Completeness of the process may be expressed as a percentage and determined by how much of the expression to be processed can be understood based on the algorithm.

The context of the semantic relevancy assessment also may be taken into account. For diseases, the relevancy context may be semantic relevancy as to a normalized expression of the disease. For example, a relevancy scale of 0 (no relevancy), 1 (some relevancy depending on the use case), 2 (moderate relevancy) and 3 (generally always relevant) may be utilized to express semantic relevancy.

The context of the semantic relevancy may also be an attribute. For example, the context may be normalizing a disease classification into a codex (ICD-10-CM). In other systems, the attribute (context) may be different. This can be mathematically expressed as expression (Exp) A 3R Exp B (Z)—wherein Exp A has the highest degree of relevancy to Exp B in the context of attribute Z.

In yet another embodiment, an advanced analysis algorithm may be based on synthetic codes (also referred to herein as “synthetic medical condition codes”). Synthetic codes may be used, for example, when the existence of multiple variables (conditions) may collectively evince a high-risk or uninsurable condition. In one embodiment, a synthetic code may be represented by the expression, S=A+B+C+D . . . , where S represents a synthetic medical condition code which is true only if A, B, C, and D are true, and where A, B, C, and D represent various medical conditions, code values, pain scales, measurements or other variables. For example, a synthetic code representing an uninsurable coronary artery disease (UCAD) condition may be true if a variable A (representing the existence of coronary artery disease) is true, and if a variable B (representing severe blockage in one or more arteries) is true (i.e., UCAD=A+B). Patient-specific synthetic codes (e.g., combinations specific to a particular patient) may be stored and accessed for processing a data-point file.

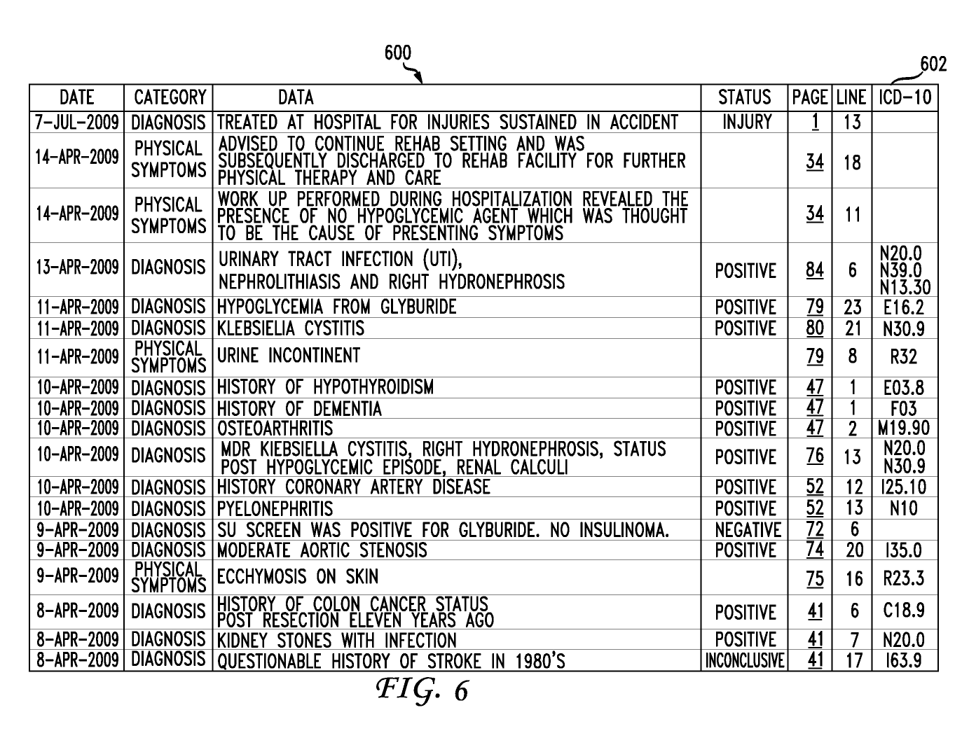

FIG. 6 illustrates a coded file wherein the data-points are coded according to one or more medical record coding standards. For example, coded file 600 may include a column 602 wherein one or more standard medical codes (such as CPT, MeSH, MIB, ICD-10, ICD-10-PCS or ICD-10-CM codes) or synthetic codes are assigned to the data-points. Further, standard industry codes may be translated into proprietary codes (such as Medical Information Bureau (MIB) Codes) for automated processing. For example, standard codes may be mapped to proprietary codes by accessing an MIB database of shared disease codes reported by the insurance industry.

When a coded file is generated, workflow manager 202 provides the coded file to generate a medical report at normalization function 228. In one embodiment, normalization engine 230 is configured to format a coded file to a standard code of disease classification, e.g., ICD-10-CM, for an automated insurance underwriting process. For example, the final normalization may be to a symbolic code that represents the disease, such as the ICD-10-CM classification (Z88.0) for an allergy to penicillin. Alternatively, a coded file can be normalized, either automatically, semi-automatically or manually (e.g., by humans), to generate a medical report. In one embodiment, normalization engine 230 may generate feedback from normalization operations that can be used to generate or improve algorithms for coding engine 226 (e.g., to improve the automatic coding process).

Additional personnel may perform quality assurance (QA) 232 on a generated medical report. For example, if a medical report does not comply with QA standards after normalization, it may be returned for error correction at 234. If the medical report passes QA at 234, the medical report may be provided to an automated insurance underwriting process (e.g., implemented at insurance client server 238), such as via a secure client upload 236. For example, a medical report may be uploaded to an automated insurance underwriting process via network 206. Alternatively, a medical report may be uploaded to insurance client server 238 via a direct interface connection 240. In one embodiment, workflow manager 202 may receive a medical report generated by the normalization engine and may be configured to upload the medical report to insurance client server 238, store the medical report at database 203 or further process the medical report (e.g., to determine a correlation between the medical report and other medical or statistical data).

It should be noted that while the one or more steps for processing a medical file are described herein as being distinct processing steps, these divisions are included solely for the purposes of clarity and ease of understanding. Moreover, one skilled in the art will recognize that one or more of the various steps may be consolidated (e.g., into fewer steps) or expanded (e.g., to include one or more additional steps or sub-steps), and that the processing steps presented herein, while exemplary, are not intended to preclude other methods of implementation.

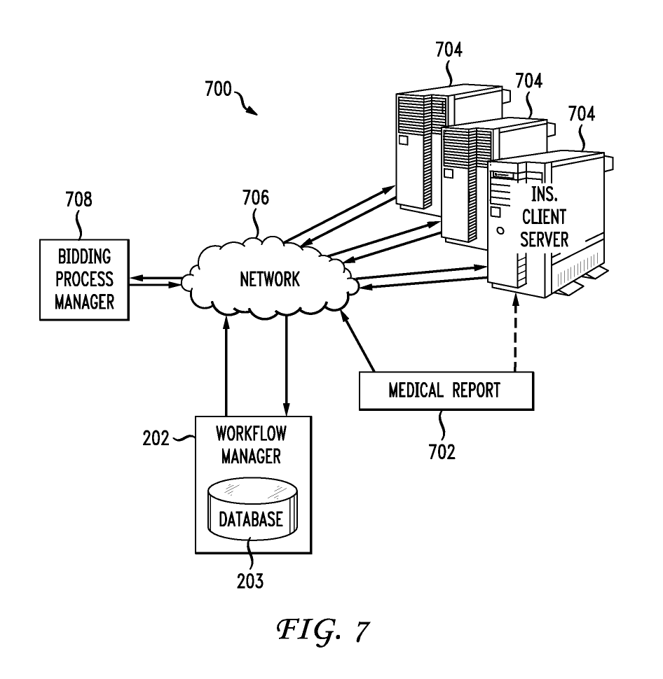

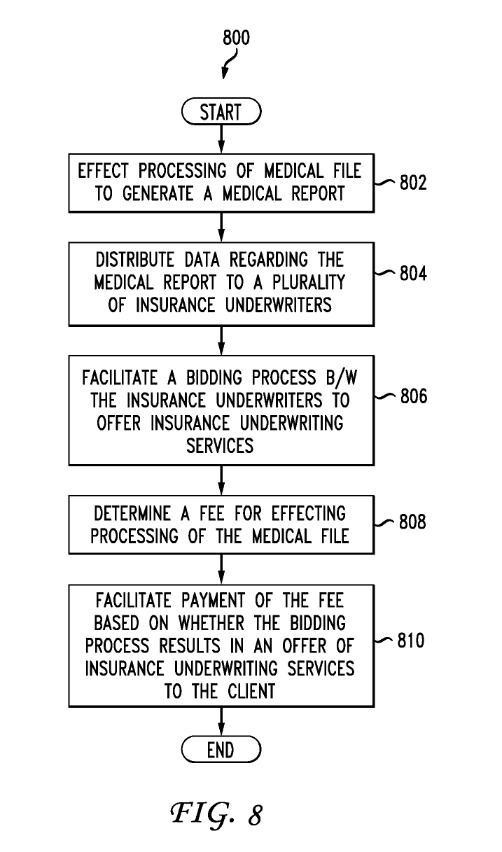

While the generated medical report may be formatted for input directly to an automated insurance underwriting process, the one or more steps for processing a medical file to generate a medical report also may be useful for implementing a shared medical data platform in which a plurality of insurance underwriters have access to data from the generated medical record. For example, a group of insurance underwriters belonging to a network may wish to share the various costs of generating medical reports. It also may be desirable to distribute the costs of generating medical reports for clients who are deemed to be uninsurable (i.e., for medical reports that cannot be underwritten). Once data regarding a medical report is accessible to a plurality of insurance underwriters, a bidding process can be conducted, either at workflow manager 202 or at another location, wherein the plurality of insurance underwriters may present offers for providing underwriting services. It should be noted that as used in the current context and in the description of FIGS. 7 and 8 below, a client may include one or more individuals associated with a medical record (e.g., a patient or a patient pool) or an agent of one or more individuals associated with a medical record (e.g., a hospital, an insurance provider or reinsurance provider, an insurance broker, etc.).

FIG. 7 is a diagram showing a system for implementing a shared medical data platform in accordance with an embodiment. In system 700, workflow manager 202 is configured to manage and/or store (via database 203) data regarding medical report 702. For example, workflow manager 202 may distribute data regarding medical report 702 to a plurality of insurance underwriters (e.g., to insurance underwriter client servers 704) via network 706. Network 706 may be a private network (e.g., a healthcare provider group intranet), a public network (e.g., the public Internet) supporting secure transmissions of machine-readable or imaged (e.g., PDF format) medical files or, alternatively, a combination of networks. Alternatively, medical report 702 may be distributed directly to the plurality of insurance underwriter servers 704 (e.g., as a result of being generated by the process described in FIG. 2 above).

In one embodiment, workflow manager 202 coordinates steps for implementing a bidding or quotation process based on distributed medical report data. For example, workflow manager 202 may invite an insurance underwriter to participate in a bidding or quotation process based on a client invitation or request, or may determine whether an insurance underwriter is associated with a group insurance underwriter network that is authorized to participate in the bidding or quotation process. Workflow manager 202 may also determine a fee for an insurance underwriter to participate in the bidding process. For example, workflow manager 202 may bill an account of one or more of the insurance underwriters based on an outcome of the bidding or quotation process. Workflow manager 202 may further facilitate automated underwriting processes based on pre-determined criteria provided by each of the participants and held in confidence by the shared medical data platform operator. For example, the automated underwriting criteria may be different for each insurance underwriter participant.

The bidding or quotation process between the plurality of insurance underwriters is implemented via bidding process manager 708. For example, bidding process manager 708 may receive bids or quotes from the plurality of insurance underwriter servers 704 via network 706 and determine an insurance underwriter associated with a winning bid or quotation (i.e., when the bidding or quotation process results in an offer of insurance underwriting services to the client associated with medical report 702), or when the bidding or quotation process does not result in an offer of insurance underwriting services. Alternatively, workflow manager 202 may conduct the bidding or quotation process between the plurality of insurance underwriters.

FIG. 8 is a flowchart of a process for implementing a shared medical data platform in accordance with an embodiment. Process 800 presents one embodiment of the methods employed for implementing a shared medical data platform. At 802, the process 800 includes effecting processing of one or more medical files to generate a medical report. As described above, the medical report may include normalized medical data, including one or more critical disease elements. The medical report also may conform to various insurance data standards, such as one or more Association for Cooperative Operations Research and Development insurance data standards (e.g., the Association for Cooperative Operations Research and Development life insurance data standards). Data may be received from the client associated with the medical report authorizing an insurance underwriter to participate in the bidding or quotation process. A medical report may be structurally grouped into categories that include general health information, disease type, symptoms of disease, injuries, general diagnostic testing, biochemistry, microbiology and pathology, imaging, endoscopy, medical procedures and surgeries, medications and prescriptions, family history and restrictions. The medical report also may include related normalized XML data.

At 804, data regarding the medical report is distributed to a plurality of insurance underwriters. The data regarding the medical report may include the entire medical report, or the data may be limited by excluding certain information (e.g., confidential or non-relevant data) from the medical report.

In one embodiment, other data may be received from the client associated with the medical report authorizing an insurance underwriter to participate in the bidding or quotation process. For example, a client may require that an insurance underwriter be invited in order to participate in the bidding or quotation process. Alternatively, the plurality of insurance underwriters may be associated with a group insurance underwriter network that is generally authorized to participate in the bidding or quotation process. In another alternative, the plurality of insurance underwriters may be associated with a group insurance underwriter network that is generally authorized to participate in the bidding or quotation process only when the bidding or quotation process relates to particular clients or client categories (e.g., high-risk potential insureds).

At 806, the data regarding the medical report is used to facilitate a bidding or quotation process between the plurality of insurance underwriters to offer insurance underwriting services to a client associated with the medical report. For example, each of the plurality of insurance underwriters may use their own insurability criteria in evaluating whether, and at what offer level, to participate in the bidding process. As such, the bidding process may be conducted independently from the implementation of the shared medical data platform (e.g., at a location other that at workflow manager 202 such as at bidding process manager 708). Alternatively, workflow manager 202 may be configured to perform operations that include managing the bidding or quotation process.

At 808, a fee is determined for effecting processing of the medical file. For example, a fee for effecting processing of the medical file may be a fixed price based on average file sizes or based on the number of elements of digital data, e.g., the cost may be linear to the quantity of digital data being extracted. At 810, payment of the fee by at least one of the plurality of insurance underwriters is facilitated based on whether the bidding or quotation process results in an offer of insurance underwriting services to the client associated with the medical report. For example, facilitating payment of the fee may include billing an account of an insurance underwriter associated with a winning bid or quotation when the bidding or quotation process results in an offer of insurance underwriting services to the client associated with the medical report. In such an instance, the cost of generating the medical report would be borne exclusively by the insurance underwriter that procures the underwriting account. In another example, facilitating payment of the fee may include billing an account of one or more of the plurality of insurance underwriters when the bidding or quotation process does not result in an offer of insurance underwriting services to the client associated with the medical report. In this instance, some percentage of the cost of generating the medical report would be borne each of by the insurance underwriters (e.g., the fee may be divided equally among the plurality of insurance underwriters that participated in the bidding or quotation process or amortized in the price/cost of successful bids or quotations. For example, the cost of unsuccessful medical file preparation may be consumed as a necessary cost of business of the successful files, assuming a minimum success rates from agents such as, for example, a minimum success rate of 50% of submissions. Accordingly, costs may need to be passed on for unsuccessful underwritings where agents have very low success rates in submissions that put pressure on overall costs. Alternatively, low-yielding agents may be assessed increased fees or dropped from the bidding pool.

Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be used within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the method steps described herein, including one or more of the steps of FIGS. 1, 2 and 8. Certain steps of the methods described herein, including one or more of the steps of FIGS. 1, 2 and 8, may be performed by a server or by another processor in a network-based cloud-computing system. Certain steps of the methods described herein, including one or more of the steps of FIGS. 1, 2 and 8, may be performed by a client computer in a network-based cloud computing system. The steps of the methods described herein, including one or more of the steps of FIGS. 1, 2 and 8, may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIGS. 1, 2 and 8, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

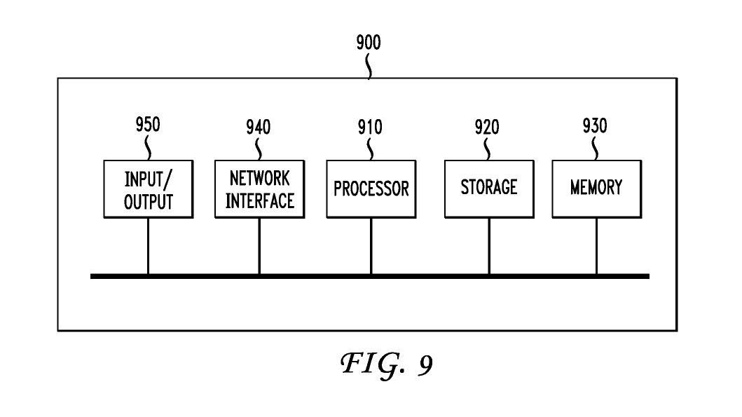

A high-level block diagram of an exemplary computer that may be used to implement systems, apparatus and methods described herein is illustrated in FIG. 9. Computer 900 comprises a processor 910 operatively coupled to a data storage device 920 and a memory 930. Processor 910 controls the overall operation of computer 900 by executing computer program instructions that define such operations. The computer program instructions may be stored in data storage device 920, or other computer readable medium, and loaded into memory 930 when execution of the computer program instructions is desired. Thus, the method steps of FIGS. 1, 2 and 8 can be defined by the computer program instructions stored in memory 930 and/or data storage device 920 and controlled by processor 910 executing the computer program instructions. For example, the computer program instructions can be implemented as computer executable code programmed by one skilled in the art to perform an algorithm defined by the method steps of FIGS. 1, 2 and 8. Accordingly, by executing the computer program instructions, the processor 910 executes an algorithm defined by the method steps of FIGS. 1, 2 and 8. Computer 900 also includes one or more network interfaces 940 for communicating with other devices via a network. Computer 900 also includes one or more input/output devices 950 that enable user interaction with computer 900 (e.g., display, keyboard, mouse, speakers, buttons, etc.).

Processor 910 may include both general and special purpose microprocessors, and may be the sole processor or one of multiple processors of computer 900. Processor 910 may comprise one or more central processing units (CPUs), for example. Processor 910, data storage device 920, and/or memory 930 may include, be supplemented by, or incorporated in, one or more application-specific integrated circuits (ASICs) and/or one or more field programmable gate arrays (FPGAs).

Data storage device 920 and memory 930 each comprise a tangible non-transitory computer readable storage medium. Data storage device 920, and memory 930, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 950 may include peripherals, such as a printer, scanner, display screen, etc. For example, input/output devices 950 may include a display device such as a cathode ray tube (CRT), plasma or liquid crystal display (LCD) monitor for displaying information to the user, a keyboard, and a pointing device such as a mouse or a trackball by which the user can provide input to computer 900.

Any or all of the systems and apparatus discussed herein, including workflow manager 202, coding engine 226, insurance client server 236 and bidding process manager 708 may be implemented using a computer such as computer 800.

One skilled in the art will recognize that an implementation of an actual computer or computer system may have other structures and may contain other components as well, and that FIG. 9 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for implementing a shared medical data platform comprising: effecting processing of a medical file to generate a medical report;
distributing data regarding the medical report to a plurality of insurance underwriters, wherein the data is used to facilitate a bidding or quotation process between the plurality of insurance underwriters to offer insurance underwriting services to a client associated with the medical report;
determining a fee for effecting processing of the medical file; and facilitating payment of the fee by at least one of the plurality of insurance underwriters based on whether the bidding or quotation process results in an offer of insurance underwriting services to the client associated with the medical report.

2. The method of claim 1 wherein facilitating payment of the fee includes billing an account of an insurance underwriter associated with a winning bid or quotation when the bidding or quotation process results in an offer of insurance underwriting services to the client associated with the medical report.

3. The method of claim 1 wherein facilitating payment of the fee includes billing an account of one or more of the plurality of insurance underwriters when the bidding or quotation process does not result in an offer of insurance underwriting services to the client associated with the medical report.

4. The method of claim 3 wherein facilitating payment of the fee includes billing an account of each of the plurality of insurance underwriters who participated in the bidding or quotation process when the bidding or quotation process does not result in an offer of insurance underwriting services to the client associated with the medical report.

5. The method of claim 1 wherein the plurality of insurance underwriters are associated with an insurance underwriter network.

6. The method of claim 1 further comprising:
receiving, from the client associated with the medical report, data authorizing an insurance underwriter to participate in the bidding or quotation process.

7. The method of claim 1 wherein the medical report conforms to one or more Association for Cooperative Operations Research and Development insurance data standards.

8. The method of claim 1 wherein the medical report includes normalized digital medical data.

9. The method of claim 8 wherein the normalized digital medical data includes one or more critical disease elements that can be used to facilitate either manual or automated life underwriting decisions.

10. The method of claim 1 wherein the medical report includes normalized XML data.

11. An apparatus for implementing a shared medical data platform comprising:
a data storage device storing computer program instructions; and
a processor communicatively coupled to the data storage device, the processor configured to execute the computer program instructions, which, when executed on the processor, cause the processor to perform a method comprising:
effecting processing of a medical file to generate a medical report;
distributing data regarding the medical report to a plurality of insurance underwriters, wherein the data is used to facilitate a bidding or quotation process between the plurality of insurance underwriters to offer insurance underwriting services to a client associated with the medical report;
determining a fee for effecting processing of the medical file; and
facilitating payment of the fee by at least one of the plurality of insurance underwriters based on whether the bidding or quotation process results in an offer of insurance underwriting services to the client associated with the medical report.

12. The apparatus of claim 11 wherein the method further comprises billing an account of an insurance underwriter associated with a winning bid or quotation when the bidding or quotation process results in an offer of insurance underwriting services to the client associated with the medical report.

13. The apparatus of claim 11 wherein the method further comprises billing an account of one or more of the plurality of insurance underwriters when the bidding or quotation process does not result in an offer of insurance underwriting services to the client associated with the medical report.

14. The apparatus of claim 13 wherein the method further comprises billing an account of each of the plurality of insurance underwriters who participated in the bidding or quotation process when the bidding or quotation process does not result in an offer of insurance underwriting services to the client associated with the medical report.

15. The apparatus of claim 11 wherein the plurality of insurance underwriters are associated with an insurance underwriter network.

16. The apparatus of claim 11 wherein the method further comprises receiving, from the client associated with the medical report, data authorizing an insurance underwriter to participate in the bidding or quotation process.

17. The apparatus of claim 11 wherein the medical report conforms to one or more Association for Cooperative Operations Research and Development insurance data standards.

18. The apparatus of claim 11 wherein the medical report includes normalized digital medical data.

19. The apparatus of claim 18 wherein the normalized digital medical data includes one or more critical disease elements that can be used to facilitate either manual or automated life underwriting decisions.

20. The apparatus of claim 11 wherein the medical report includes normalized XML data.

21. A computer readable medium storing computer program instructions for implementing a shared medical data platform, which, when executed on a processor, cause the processor to perform a method comprising:
effecting processing of a medical file to generate a medical report;
distributing data regarding the medical report to a plurality of insurance underwriters, wherein the data is used to facilitate a bidding or quotation process between the plurality of insurance underwriters to offer insurance underwriting services to a client associated with the medical report;
determining a fee for effecting processing of the medical file; and
facilitating payment of the fee by at least one of the plurality of insurance underwriters based on whether the bidding or quotation process results in an offer of insurance underwriting services to the client associated with the medical report.

22. The computer readable medium of claim 21 wherein the method further comprises billing an account of an insurance underwriter associated with a winning bid or quotation when the bidding or quotation process results in an offer of insurance underwriting services to the client associated with the medical report.

23. The computer readable medium of claim 21 wherein the method further comprises billing an account of one or more of the plurality of insurance underwriters when the bidding or quotation process does not result in an offer of insurance underwriting services to the client associated with the medical report.

24. The computer readable medium of claim 23 wherein the method further comprises billing an account of each of the plurality of insurance underwriters who participated in the bidding or quotation process when the bidding or quotation process does not result in an offer of insurance underwriting services to the client associated with the medical report.

25. The computer readable medium of claim 21 wherein the method further comprises receiving, from the client associated with the medical report, data authorizing an insurance underwriter to participate in the bidding or quotation process.

26. The computer readable medium of claim 21 wherein the medical report conforms to one or more Association for Cooperative Operations Research and Development insurance data standards.

27. The computer readable medium of claim 21 wherein the medical report includes normalized digital medical data.

28. The computer readable medium of claim 27 wherein the normalized digital medical data includes one or more critical disease elements that can be used to facilitate either manual or automated life underwriting decisions.

29. The computer readable medium of claim 21 wherein the medical report includes normalized XML data.
